(19) United States
(12) Patent Application Publication
(10) Pub. No.: US 2009/0260080 A1
(43) Pub. Date: Oct. 15, 2009

(54) SYSTEM AND METHOD FOR VERIFICATION OF DOCUMENT PROCESSING DEVICE SECURITY BY MONITORING STATE TRANSISTIONS

(76) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/102,039

(22) Filed: Apr. 14, 2008

(51) Int. Cl. G06F 12/14

(52) U.S. Cl. 726/22

(57) ABSTRACT

The subject application is directed to a system and method for verification of document processing device security by monitoring of state transitions. State data is first acquired corresponding to a monitored sequence of states entered by a document processing device during operations and stored in an associated data storage. Authenticity data is thereafter generated representing the authenticity of the stored state data. State template data is then stored in the associated data storage corresponding to at least one acceptable sequence of states. Destination data is also stored in the associated data storage representing at least one preselected notification destination. A comparison is then performed of the acquired state data and the template state data. Notification data is then output based upon the result of the comparison of the state data and the state template data.

### BACKGROUND OF THE INVENTION

The subject application is directed generally to ensuring security in operation of digital devices. The application is particularly applicable to verifying that a device, such as a document processing device, is operating as expected so as to allow for detection of an authorized breach.

Originally, logic-based digital devices, such as digital data processing devices, were used as programmable, general purpose computers. The devices included at least one central processing unit or CPU, data storage such as random access memory (RAM), frequently supplemented with nonvolatile or mass data storage, input/output capability, such as a keyboard or pointing device, and a visual output. Such digital devices operate under programmed routines, or software. Software causes changes in values or locations in which data is stored, including data stored in RAM or other storage, as well as values stored on a CPU itself, such as in register values, program counter values, and the like. In addition, digital values exist that represent a status of other devices, such as peripheral devices including printers, network data connections, or other devices or connections. At any given moment, values associated with these various locations or devices define a snapshot of settings or operation of a digital device. Such a snapshot is referred to a “state” of a device. As such, digital devices, such as computers, are sometimes referred to as state machines.

Operation of logical devices is suitably defined as a series of possible states. Once available states are understood, it is possible to define logic that allows for transitioning between states under selected conditions. A simplistic example is available with reference to a light bulb with two switches. Most households or businesses have at least one light bulb that can be independently toggled on or off from two, distinct switches. Either switch has two positions. If a bulb is illuminated, changing a position of either switch will turn it off. If a bulb is dark, changing a position of either switch will turn it on. The state of the bulb is switched from on to off by changing any position of either switch, irrespective of that position. While a typical wiring application accomplishes three way operation with the use of specialized switches and wiring, a state machine can accomplish the same task with only an “on” or “off” setting for each switch, such as with a standard one way switch. The next state of the lamp is dictated by both the current state of the lamp and a change in value of the state of one of the switches. Illumination at current and altered positions of one switch (SW1), which occurs irrespective of a position of the second switch (SW2), is dictated by a transition between the SW1 positions. It will be appreciated that the same functionality is to be realized for the switch SW2 relative to SW1, since the two switches operate identically in the example.

| SW1 (before) | SW1 (after) | SW2 | Lamp (before) | Lamp (after) |
|---|---|---|---|---|
| open | open | X | on | on |
| open | closed | X | on | off |
| closed | open | X | on | off |
| closed | closed | X | on | on |
| open | open | X | off | off |
| open | closed | X | off | on |
| closed | open | X | off | on |
| closed | closed | X | off | off |

From the table, above, it will be appreciated that the state of the logic at any given time in the example is suitably defined by switch position, switch transition and illumination state of the lamp. Thus, a status of the system at any given time is realizable by the status of the various components, also known as the system state.

There are two basic ways that machine states are typically described. A machine that uses entry actions, and wherein a current output depends only on a current state, is typically described as a Moore machine. A machine that uses a current machine state, along with inputs, to describe a transition to another state, is typically described as a Mealy machine. A choice of a particular model is typically made based on a particular application. Mixed models, employing both Moore and Mealy, are also used. The example, noted above, is probably easiest to describe as a Mealy machine given its state transitions triggered by toggling of switch position.

While logical devices, such as state machines, were used earlier on as general purpose computers, they have been engrafted to use in digital devices, such as control systems, consumer electronic devices and office machines. Modern day office machines include copiers, scanners, printers, and facsimile machines. More recently, two or more of these functions are included in devices called multifunction peripherals or MFPs. Control of complex or multifunction document processing devices frequently employs dedicated digital processing devices, referred to as controllers, which may essentially be thought of as digital computers operating in a hardware and software environment tailored to document processing needs.

Since modern document processing devices include programmable features, they are subject to intrusion, such as by one who is able to engraft rogue instructions into a processing stream or otherwise divert processing to perform unintended tasks. By way of example, a modern document processing machine could be programmed to relay sensitive information to an unintended recipient, or divert or mask costs of operation. While such instructions can be inserted at any time, a document processing device is particularly vulnerable at times, such as boot up.

### SUMMARY OF THE INVENTION

In accordance with one embodiment of the subject application, there is provided a system and method for ensuring security in operation of digital devices.

Further, in accordance with one embodiment of the subject application, there is provided a system and method for verifying that a device, such as a document processing device, is operating as expected so as to allow for detection of an authorized breach.

Still further, in accordance with one embodiment of the subject application, there is provided a system for verification of document processing device security by monitoring of state transitions. The system comprises monitoring means adapted for acquiring state data corresponding to a monitored sequence of states entered by a document processing device during operation thereof and a data storage including means adapted for storing state data acquired by the monitoring means. The system also includes authentication means adapted for generating data representative of authenticity of state data stored in the data storage. In addition, the data storage further comprising means adapted for storing state template data corresponding to at least one acceptable sequence of states and means adapted for storing destination data representative of at least one preselected notification destination. The system also comprises comparison means adapted for comparing state data with state template data and notification means adapted for outputting notification data to the at least one preselected destination in accordance with an output of the comparison means and stored destination data.

Further, in accordance with one embodiment of the subject application, there is provided a method for verification of document processing device security by monitoring of state transitions. The method includes the steps of acquiring state data that corresponds to a monitored sequence of states that are entered by a document processing device during its operations, and storing the acquired state data in an associated data storage. Data is generated representing the authenticity of state data stored in the associated data storage. State template data corresponding to at least one acceptable sequence of states and destination data corresponding to at least one preselected notification destination are also stored in the associated data storage. The state data is then compared with the state template data and notification data is output to the at least one preselected destination in accordance with an output of the comparison step and the stored destination data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for verification of document processing device security by monitoring of state transitions according to one embodiment of the subject application;

FIG. 2 is a block diagram illustrating controller hardware for use in the system for verification of document processing device security by monitoring of state transitions according to one embodiment of the subject application;

FIG. 3 is a functional diagram illustrating the controller for use in the system for verification of document processing device security by monitoring of state transitions according to one embodiment of the subject application;

FIG. 4 is a flowchart illustrating a method for verification of document processing device security by monitoring of state transitions according to one embodiment of the subject application; and

FIG. 5 is a flowchart illustrating a method for verification of document processing device security by monitoring of state transitions according to one embodiment of the subject application.

### DETAILED DESCRIPTION OF THE PREFERRED EMBODIMENT

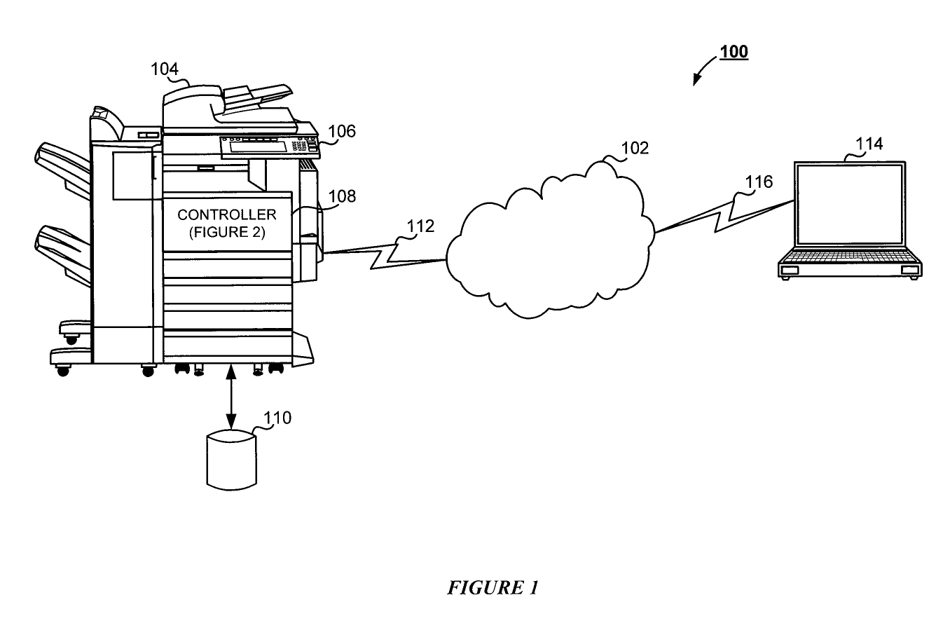

The subject application is directed to a system and method for ensuring security in operation of digital devices. In particular, the subject application is directed to a system and method for verifying that a device, such as a document processing device, is operating as expected so as to allow for detection of an authorized breach. More particularly, the subject application is directed to a system and method for verification of document processing device security by monitoring of state transitions. It will become apparent to those skilled in the art that the system and method described herein are suitably adapted to a plurality of varying electronic fields employing state-based security, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for verification of document processing device security by monitoring of state transitions in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

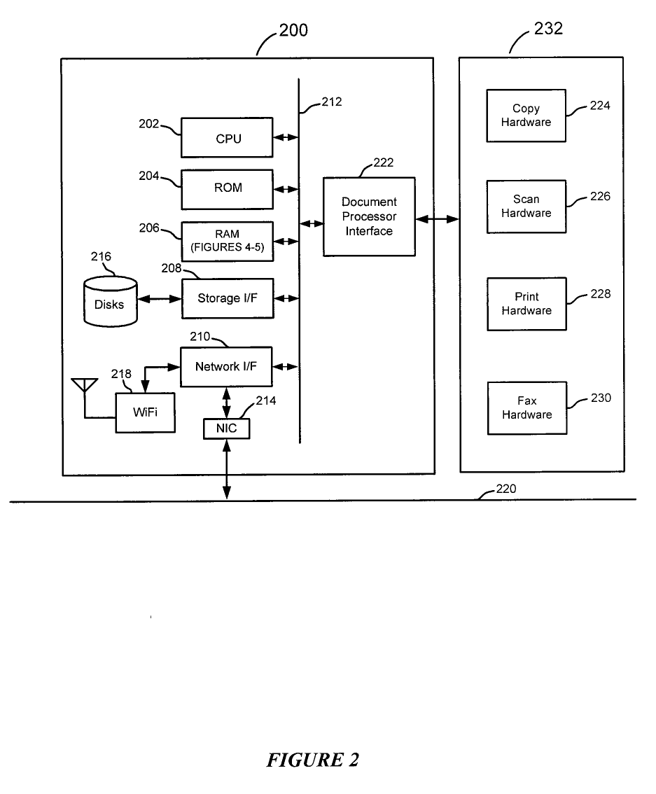

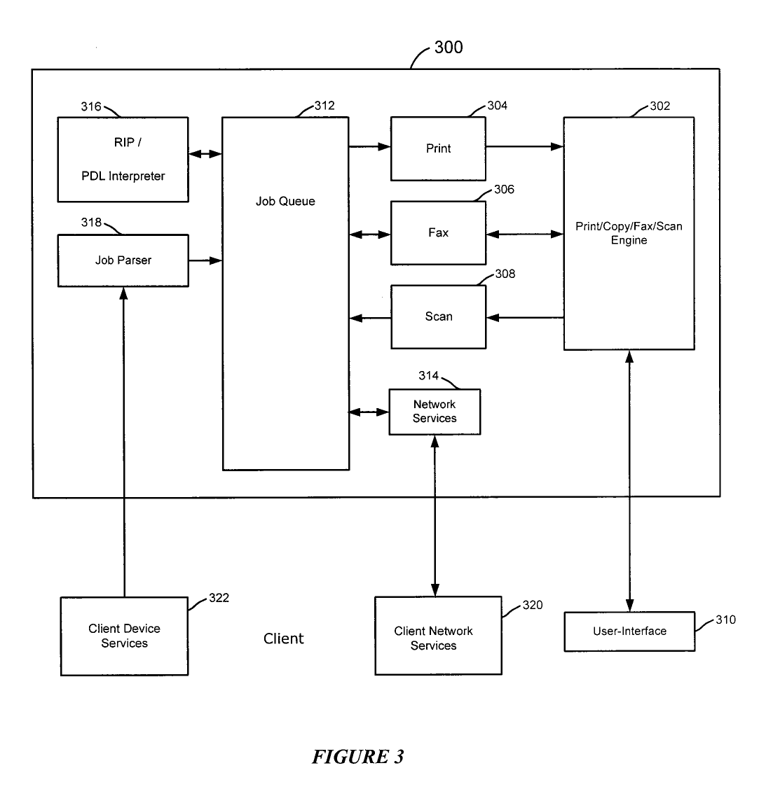

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for verification of document processing device security by monitoring of state transitions of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts an administrative device 114, in data communication with the computer network 102 via a communications link 116. It will be appreciated by those skilled in the art that the administrative device 114 is shown in FIG. 1 as a laptop computer for illustration purposes only. As will be understood by those skilled in the art, the administrative device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 114 is suitably adapted to receiving monitored state data from the associated document processing device 104, analyze data returned by the associated document processing device 104, determine security breaches, provide preventative measures, receive alerts, and the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. The illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become the document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, state data is first acquired corresponding to a monitored sequence of states entered by a document processing device during operations. The acquired state data is then stored in an associated data storage. Authenticity data is thereafter generated representing the authenticity of state data stored in the associated data storage. State template data is then stored in the associated data storage corresponding to at least one acceptable sequence of states. Destination data is also stored in the associated data storage representing at least one preselected notification destination. The state data is then compared with the state template data and notification data is then output based upon the output of the comparison of the state data and the state template data.

According to one example embodiment of the subject application, the controller 108 or other suitable component associated with the document processing device 104 preferably monitors the operations of the document processing device 104 via hardware, software, or a combination thereof. The controller 108 suitably monitors the state information associated with the operations of the document processing device 104 such that state data corresponding to a monitored sequence of states entered by the document processing device 104 is acquired by the controller 108. The controller 108 or other suitable component associated with the document processing device 104 then facilitates the storage of the acquired state data in the memory 110 associated with the document processing device 104, in system memory associated with the document processing device 104, or other such memory accessible by the controller 108, as will be appreciated by those skilled in the art. In accordance with one embodiment of the subject application, the state data corresponds to each transition between states of the monitored sequence of states, as well as data corresponding to an identity of each monitored state.

The controller 108 or other suitable component associated with the document processing device 104 then generates data corresponding to the authenticity of the state data stored in the associated data storage device 110. In accordance with one embodiment of the subject application, the authenticity is generated in accordance with a form of encryption, digital signing, or the like, so as to ensure the state data stored therein remains unmodified, i.e. secure. Template data is then stored in the associated data storage device 110 corresponding to an acceptable sequence of states. Preferably, the acceptable sequence of states corresponds to a normal sequence of states through which the document processing device 104, the controller 108, or other suitable component associated with the document processing device 104, transits during normal trusted operations. It will be appreciated by those skilled in the art that the template data is input by the manufacturer of the device 104, the vendor of the device 104, a system administrator associated with the device 104, or the like. The skilled artisan will further appreciate that such template data is capable of being generated by the document processing device 104 independent of the administrator prior to the installation of the device 104, i.e. during normal trusted operations of the device 104.

Preselected destination data is also stored in the associated data storage device 110 corresponding to a desired destination for notification of the status of the document processing device 104. In accordance with one embodiment of the subject application, the destination data includes an electronic mail address of an associated administrator, an IP or network address associated with the administrative device 114, a pager or telephone number, or the like. It will be appreciated by those skilled in the art that the destination data corresponds to any suitable destination for a notification generated for an administrator or other authorized user in accordance with the subject application.

The acquired state data is then compared to the stored template data so as to determine whether the state transitions of the state data match those of the template data, indicating normal trusted operations of the document processing device 104. Preferably, the controller 108 or other suitable component associated with the document processing device 104 retrieves the template data from the data storage device 104 and the state data of the monitored sequence of states and compares the two sets of data. When all states, or state transitions, of the acquired state data match those of the template, the controller 108 or other suitable component associated with the document processing device 104 determines that normal trusted operations of the document processing device 104, and returns to monitoring the sequence of states entered by the document processing device 104.

In the event that the acquired state data does not match that of the template, notification data is output to destination in accordance with the stored destination data. That is, when one or more of the state transitions recorded in the state data is missing, modified, or otherwise inconsistent with the template data, a breach or error in the operations of the document processing device 104 has occurred. Upon such an occurrence, the controller 108 or other suitable component associated with the document processing device 104 retrieves the destination data from storage 110 and generates a suitable notification indicating the breach or error in operations, e.g. electronic mail message, web-based notification, SMS text message, command prompt, voice communication, or the like. The notification is then output to the destination via the computer network 102. In accordance with one embodiment of the subject application, the notification includes, for example and without limitation, a portion of the acquired state data, data corresponding to each transition between monitored states, identification of monitored states, and the like.

The controller 108 or other suitable component associated with the document processing device 104 then generates log data relative to the altered states, e.g. the states or state transitions that do not correlate to the template data. The log data is preferably stored on the associated data storage device 110 for later retrieval by an administrator, authorized user, remote access from the administrative device 114, or the like. In accordance with one embodiment of the subject application, the log data includes time/date information, state identification information, state transition information, job processing information, or the like. Preferably, the log data stored in the associated data storage 110 is signed using a private key associated with the document processing device 104.

A determination is then made whether or not to suspend all operations of the document processing device 104 as a result of the breach or error. In the event that a full suspension of operations is required, the controller 108 or other suitable component associated with the document processing device 104 ceases operations of the document processing device 104 and functions to protect any data stored thereon until control data is received from a suitable administrator or authorized user. That is, the controller 108 locks the document processing device 104, preventing any further document processing operations to be performed thereon. When full suspension of the services provided by the document processing device 104 is not warranted, the trusted state operations of the document processing device 104 is suspended until suitable control data is received from an administrator or authorized user, e.g. the document processing device 104 ceases accepting confidential processing jobs.

Upon receipt of control data from the administrator, e.g. a communication from the administrative device 114 inclusive of control data, the controller 108 or other suitable component associated with the document processing device 104 alters the operations of the document processing device 104 in accordance with the control data. In accordance with one embodiment of the subject application, the control data represents commands from the administrator or other authorized user corresponding to operations of the associated document processing device 104.

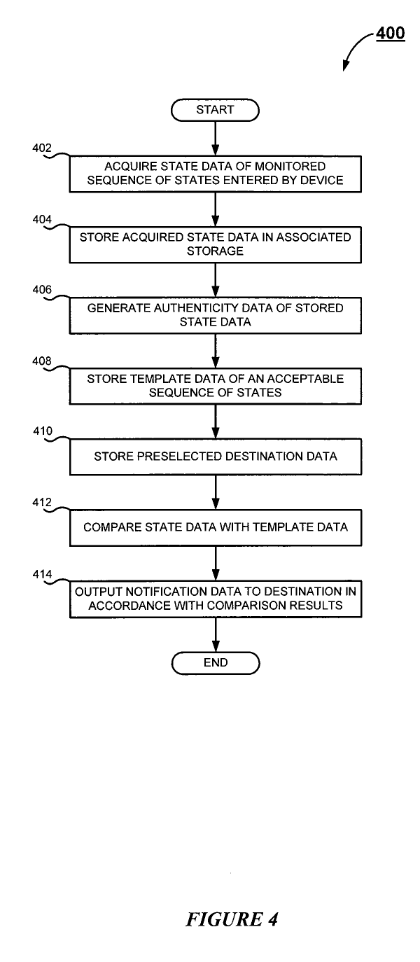

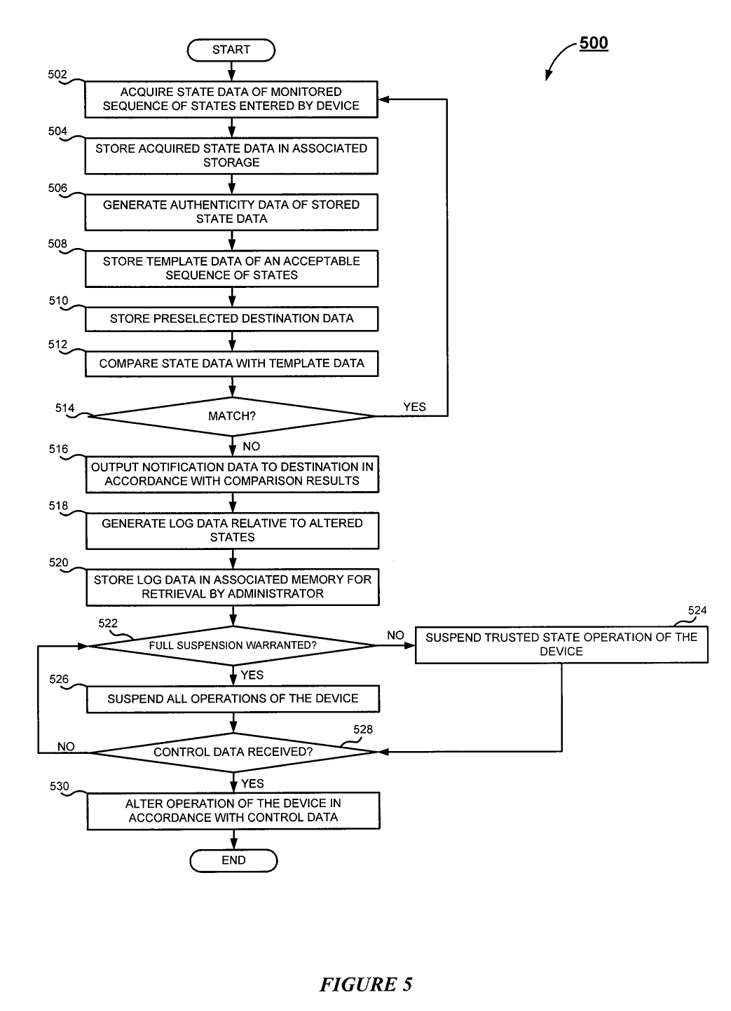

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for verification of document processing device security by monitoring of state transitions in accordance with one embodiment of the subject application. Beginning at step 402, the controller 108 or other suitable component associated with the document processing device 104 acquires state data corresponding to a monitored sequence of states entered by the document processing device 104 during an operation, e.g. a document processing operation, device startup, device shutdown, or the like. In accordance with one embodiment of the subject application, the acquired state data includes state transition data, as will be appreciated by those skilled in the art.

At step 404, the document processing device 104, via the controller 108 or other suitable component associated therewith, stores the acquired state data in associated data storage 110. Authenticity data is then generated at step 406 representative of the authenticity of state data stored in the associated data storage 110. According to one embodiment of the subject application, the authenticity data includes, for example and without limitation, a digital signature, encryption, or other suitable means of providing authentication, as will be appreciated by one skilled in the art.

State template data is then stored in the associated data storage 110 at step 408 corresponding to at least one acceptable sequence of states. Preferably, the controller 108 or other suitable component associated with the document processing device 104 stores a template sequence of states, or state transitions, that are indicative of normal operations of the document processing device 104. It will be appreciated by those skilled in the art that such template data is capable of being received from an administrator or authorized user, a manufacturer, a vendor, or the like. According to one embodiment of the subject application, an administrator associated with the administrative device 114 communicates suitable template data to the document processing device 104 via the computer network 102.

At step 410, preselected destination data is stored in the associated data storage representing at least one preselected notification destination in the event of a breach of the security of the document processing device 104. In accordance with one embodiment of the subject application, the notification destination corresponds to a preselected to destination to which a notification message or alert is to be sent in the event of a security breach or error in operations of the document processing device 104. The acquired state data is then compared to the template data at step 412 by the controller 108 or other suitable component associated with document processing device 104. At step 414, the controller or other suitable component associated with the document processing device 104 then outputs notification data to a destination in accordance with the results of the comparison. For example, when a breach in the security of the document processing device 104 has occurred, a notification message, inclusive of the acquired state data, is communicated to the administrative device 114 via the computer network 102.

Referring now to FIG. 5, there is shown a flowchart 500 illustrating a method for verification of document processing device security by monitoring of state transitions in accordance with one embodiment of the subject application. The method depicted in FIG. 5 begins at step 502, whereupon a controller 108 or other suitable component associated with a document processing device 104 acquires state data corresponding to the monitoring of a sequence of states entered by the document processing device 104 during operations via hardware, software, or a combination thereof.

The acquired state data is then stored in an associated data storage 110 at step 504 via operations of the controller 108 or other suitable component associated with the document processing device 104. The skilled artisan will appreciate that other data storage devices are capable of being used to store the acquired state data including, for example and without limitation, system memory associated with the document processing device 104, memory accessible by the controller 108, and the like. In accordance with one embodiment of the subject application, the state data corresponds to each transition between states of the monitored sequence of states, as well as data corresponding to an identity of each monitored state.

At step 506, the controller 108 or other suitable component associated with the document processing device 104 generates data corresponding to the authenticity of the stored state data. It will be appreciated by those skilled in the art that any suitable means of authenticating such data are capable of being used including, for example and without limitation, encryption, digital signing, and the like. The controller 108 or other suitable component associated with the document processing device 104 then stores template state data corresponding to an acceptable sequence of states at step 508. In accordance with one embodiment of the subject application, the acceptable sequence of states corresponds to a normal sequence of states, or state transitions, through which the document processing device 104, the controller 108, or other suitable component associated with the document processing device 104, progresses during normal trusted operations. According to one embodiment of the subject application, the template data is capable of being received from the administrative device 114, a manufacturer, a vendor, a supplier, or the like. In accordance with one example embodiment of the subject application, the template data is generated by the document processing device 104 during the course of performing a normal trusted operation.

At step 510, preselected destination data is stored in the associated data storage device 110 corresponding to a desired destination for notification of the status of the document processing device 104. Those skilled in the art will appreciate that suitable destination data includes, for example and without limitation, an electronic mail address of an associated administrator, an IP or network address associated with an administrative device 114, a pager number, a telephone number, or the like. Thus, it will be understood by those skilled in the art that the destination data represents any suitable destination to which a notification is sent for an administrator or other authorized user in accordance with the subject application.

A comparison is then made at step 512 with respect to the stored template data and the acquired state data. The controller 108 or other suitable component associated with the document processing device 104 then determines, at step 514, whether the template data matches the acquired state data. That is, the controller 108 determines whether the state transitions set in the template data match those state transitions of the acquired data, thereby indicating that no breach of security has occurred. When no breach is thus detected, operations return to step 502, whereupon new state data is acquired and the process repeats. In the event that the state transitions of the template data and the acquired data do not correlate, the controller 108 or other suitable component associated with the document processing device 104 then determines that a breach of security has occurred.

When one or more of the state transitions recorded in the state data is missing, modified, or otherwise inconsistent with the template data, a breach in the operations of the document processing device 104 is determined to have occurred, flow proceeds to step 516, whereupon notification data is output to the destination in accordance with the stored destination data. In accordance with one embodiment of the subject application, the controller 108 or other suitable component associated with the document processing device 104 retrieves the destination data from storage 110 and generates a suitable notification indicating the breach or error in operations, e.g. electronic mail message, web-based notification, SMS text message, command prompt, voice communication, or the like. Preferably, this notification is output to the destination via the computer network 102. In accordance with one embodiment of the subject application, the notification includes, for example and without limitation, a portion of the acquired state data, data corresponding to each transition between monitored states, identification of monitored states, and the like.

Log data is then generated by the controller 108 or other suitable component associated with the document processing device 104 at step 518 relative to the altered states, e.g. the states or state transitions that do not correlate to the template data.

At step 520, the controller 108 or other suitable component associated with the document processing device 104 facilitates the storage of the log data on the associated data storage device 110 for later retrieval by an administrator, authorized user, remote access from the administrative device 114, or the like. It will be appreciated by those skilled in the art that the log data includes, for example and without limitation, time/date information, state identification information, state transition information, job processing information, or the like. In accordance with one embodiment of the subject application, the log data is signed using a private key associated with the document processing device 104 so as to ensure the authenticity and reliability thereof.

A determination is then made at step 522 whether suspension of all operations of the document processing device 104 is warranted in response to the detected security breach. Upon a negative determination at step 522, flow proceeds to step 524, whereupon trusted state operations of the document processing device 104 are suspended. Upon a positive determination at step 522, flow proceeds to step 526, whereupon all operations of the document processing device 104 are suspended. Following suspension at either step 524 or step 526, operations proceed to step 528, whereupon a determination is made whether control data has been received. That is, whether or not an administrator has communicated control data to the document processing device 104 in response to the notification. Upon a determination at step 528 that control data has been received, e.g. a communication from the administrative device 114 inclusive of control data, the controller 108 or other suitable component associated with the document processing device 104 alters the operations of the document processing device 104 in accordance with the control data at step 530. When control data has not been received at step 528, flow returns to step 522, whereupon the operations continue as set forth above until control data is received. For example, the document processing device 104 remains locked, i.e. unable to perform one or more document processing operations, thereby preventing the further breaches in security.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for verification of document processing device security by monitoring of state transitions comprising:
monitoring means adapted for acquiring state data corresponding to a monitored sequence of states entered by a document processing device during operation thereof;
a data storage including means adapted for storing state data acquired by the monitoring means;
authentication means adapted for generating data representative of authenticity of state data stored in the data storage;
the data storage further comprising means adapted for storing state template data corresponding to at least one acceptable sequence of states;
the data storage further comprising means adapted for storing destination data representative of at least one preselected notification destination;
comparison means adapted for comparing state data with state template data; and
notification means adapted for outputting notification data to the at least one preselected destination in accordance with an output of the comparison means and stored destination data.

2. The system of claim 1 wherein the notification data includes at least a portion of acquired state data.

3. The system of claim 2 wherein the state data includes data corresponding to each transition between states of the monitored sequence of states.

4. The system of claim 2 wherein the state data includes data corresponding to an identity of each state of the monitored sequence of states.

5. The system of claim 2 further comprising:
means adapted for receiving control data relative to modified control of the document processing device after outputting of notification data by the notification means; and
means adapted for altering operation of the document processing device in accordance with received control data.

6. The system of claim 5 further comprising means adapted for suspending operation of the document processing device prior to receipt of control data.

7. A method for verification of document processing device security by monitoring of state transitions comprising the steps of:
acquiring state data corresponding to a monitored sequence of states entered by a document processing device during operation thereof;
storing state data acquired by the monitoring step in an associated data storage;
generating data representative of authenticity of state data stored in the associated data storage;
storing state template data corresponding to at least one acceptable sequence of states in the associated data storage;
storing destination data representative of at least one preselected notification destination in the associated data storage;
comparing state data with state template data; and
outputting notification data to the at least one preselected destination in accordance with an output of the comparison step and stored destination data.

8. The method of claim 2 wherein the notification data includes at least a portion of acquired state data.

9. The method of claim 8 wherein the state data includes data corresponding to each transition between states of the monitored sequence of states.

10. The method of claim 8 wherein the state data includes data corresponding to an identity of each state of the monitored sequence of states.

11. The method of claim 8 further comprising the steps of:
receiving control data relative to modified control of the document processing device after outputting of notification data by the notification step; and
altering operation of the document processing device in accordance with received control data.

12. The method of claim 11 further comprising the step of suspending operation of the document processing device prior to receipt of control data.
